(19) United States
(12) Patent Application Publication
(10) Pub. No.: US 2011/0060585 A1
(43) Pub. Date: Mar. 10, 2011

(54) INPUTTING METHOD BY PREDICTING CHARACTER SEQUENCE AND ELECTRONIC DEVICE FOR PRACTICING THE METHOD

(76) Inventor: Eui Jin Oh, Daejeon (KR)

(21) Appl. No.: 12/865,729

(22) PCT Filed: Feb. 2, 2009
(86) PCT No.: PCT/KR09/00513

§ 371 Date: Nov. 1, 2010

(30) Foreign Application Priority Data
Feb. 1, 2008 (KR) 10-2008-0010457

(51) Int. Cl. G06F 17/27

(52) U.S. Cl. 704/9

(57) ABSTRACT

The present invention relates to a method of predicting and entering a character string and an electronic device in which the method is implemented. The method of predicting and entering a character string includes a step (S10) of entering a first letter and a second letter in an entry device in order of arrangement of the first letter and the second letter until each of the first letter and the second letter is displayed on a display window once or more; a step (S20) of entering a first first letter from among the first letters existing in the character string after the first letters and the second letters; a step (S30) of predicting a prediction character string group of 1 to N columns, including the three or more letters, as a candidate of the character string and displaying the predicted prediction character string group; a step (S40) of primarily selecting an intended character string from an N number of character strings in the prediction character string group; a step (S50) of sequentially entering subsequent first letters existing in the character string after the first first letter; a step (S60) of rearranging the prediction character string group in 1 to n columns by deleting character strings, not including the sequentially entered first letters, from the prediction character string group whenever the first letters are sequentially entered; and a step (S70) of secondarily selecting any one of the n number of character strings remaining in the prediction character string group.

### TECHNICAL FIELD

The present invention relates to a method of predicting and entering a character string and an electronic device in which the method is implemented, and more particularly, to a method of predicting and entering a character string and an electronic device in which the method is implemented, in which a prediction character string group of an intended character string is generated by entering some consonants or vowels included in the character string and the character string is easily and fast selected from the prediction character string group.

### BACKGROUND ART

Lots of researches have been done to reduce a user's efforts to perform key entry in which all letters assigned to respective keys must be entered when the user enters a letter through the key entry and to improve the convenience of entry.

As a result of the researches, there is a method of, when a user enters some letters of a word at the beginning, predicting the remaining letters. This method requires the user to enter basic letters forming the front part of the word that the user actually wants to enter. In other words, for example, if a user is sought to enter an English word ‘communication’, the user must enter all letters in order of the letters arranged until the character string ‘communication’ is selected from a prediction word group. Furthermore, the user must enter at least ‘communic’ because there are many words, such as ‘communicate’, which are similar to the word ‘communication’. Accordingly, if a word is long, a user must inconveniently perform a lot of key entry in order to enter one word.

Further, in a conventional method, all letters corresponding to a word to be entered must be correctly entered until the word is selected. For example, in the case in which a user wants to enter the character string ‘communication’, but does not fully remember the consonants and the vowels of the character string ‘communication’ (e.g., in the case in which the user does not clearly know whether ‘u’ or ‘e’ follows ‘comm’), the user feels difficult to enter the character string ‘communication’, and there is a problem in that a task of entering the entire word is delay because one vowel is not known to the user.

In addition, in a conventional method, in order to select an intended word from a prediction word group, a cursor or an active block must be moved to a column where the corresponding word is disposed using a direction key (▾ or ▴). For example, in the case in which up to ‘communic’ is entered in order to enter the word ‘communication’, in a conventional method, a group of prediction words including the ‘communic’ are arranged in series. In order to select the word ‘communication’ from the prediction word group, the direction key (▾ or ▴) must be pressed plural times so that it is moved to a column where the word ‘communication’ is disposed in the prediction word group.

Accordingly, since the direction key is pressed plural times, the number of entries is increased. Further, the time that it takes to enter a word is increased because the direction key is a function key not frequently used in a common document task. In addition, a user's fatigue is increased because of the plurality of consecutive key entries. For this reason, a user rarely uses the conventional method in order to consecutively enter a plurality of words.

### DISCLOSURE

### Technical Problem

Accordingly, the present invention has been made in view of the above problems, and it is an object of the present invention to provide a method of predicting and entering a character string and an electronic device in which the method is implemented, in which an intended character string can be selected by entering only some letters of the intended character string.

It is another object of the present invention to provide a method of predicting and entering a character string and an electronic device in which the method is implemented, in which even though a user does not correctly remember all letters forming a character string, the corresponding character string can be entered.

It is yet another object of the present invention to provide a method of predicting and entering a character string and an electronic device in which the method is implemented, which are capable of entering a character string while minimizing the use of function keys other than character enter keys.

### Technical Solution

To achieve the above objects, according to an aspect of the present invention, a first invention relates to a method of predicting and entering a character string. The method includes a step (S10) of, in order to enter a character string composed of a combination of a first letter and a second letter, entering the first letter and the second letter in an entry device in order of arrangement of the first letter and the second letter belonging to the character string until each of the first letter and the second letter is displayed on a display window once or more; a step (S20) of entering a first first letter from among the first letters existing in the character string after the first letters and the second letters are entered; a step (S30) of predicting a prediction character string group of 1 to N columns, including the three or more letters, as a candidate of the character string on the basis of the entered three or more letters and displaying the predicted prediction character string group on the display window; a step (S40) of primarily selecting an intended character string by pressing a selection key if the intended character string exists in a first column of the prediction character string group composed of an N number of character strings, by entering a first letter or a second letter appearing immediately after the first first letter, from among the N number of character strings, and belonging to the intended character string if the first letter or the second letter immediately after the first first letter differs, or by pressing a search key if different second letters exist before a position corresponding to the first first letter in the N number of character strings and then entering the second letters belonging to the intended character string; a step (S50) of, if the intended character string is not selected in the primary selection step, sequentially entering subsequent first letters existing in the character string after the first first letter; a step (S60) of rearranging the prediction character string group in 1 to n columns by deleting character strings, not including the sequentially entered first letters, from the prediction character string group whenever the first letters are sequentially entered; and a step (S70) of secondarily selecting any one of the n number of character strings remaining in the prediction character string group.

According to a second invention, the step (S20) of entering the first first letter in the first invention further comprises a step (S21) of entering one or more of the second letters of the intended character string, existing between the previously entered first and second letters and a first first letter now being entered, before entering the first first letter.

Here, in the step (S30) of displaying the prediction character string group, the prediction character string group is generated on the basis of the previously entered first and second letters, one or more second letters entered in the above step, and the first first letter.

According to a third invention, in the sequential entry step (S50) of the first invention, one or more of second letters disposed between the subsequent first letters, together with the subsequent first letters, are entered in order of arrangement of the letters of the character string. In the rearrangement step (S60), the prediction character string group, including the entered one or more second letters, is rearranged.

According to a fourth invention, in the secondary selection step (S70) of the first invention, a character string disposed in the first column of the prediction character string group arranged in the 1 to n columns is selected by pressing the selection key.

According to a fifth invention, in the secondary selection step (S70) of the first invention, if a first letter or a second letter immediately after a letter now being entered differs in each of the character strings included in the prediction character string group arranged in the 1 to n columns, a character string belonging to a prediction character string group, including the first letter or the second letter, is selected by entering a first letter or a second letter to distinguish the character strings from each other.

According to a sixth invention, in the secondary selection step (S70) of the first invention, if there is a different second letter before a position corresponding to a first or second letter now being entered in an n number of character strings, the intended character string is selected by pressing the search key and then entering the second letter belonging to the intended character string.

According to a seventh invention, in the fifth invention, the first or second letter to distinguish the character strings from each other is distinguished from previously displayed characters and displayed.

According to an eighth invention, in any one of the first to sixth inventions, the first letter is a consonant, and the second letter is a vowel.

According to a ninth invention, in any one of the first to sixth inventions, in the step (S30) of displaying the prediction character string group, the prediction character string group is sequentially arranged starting from a first column of a prediction word group in order of character strings of high frequency.

A tenth invention relates to an electronic device which implements the entry of letters using a method of predicting and entering a character string according to any one of the first to sixth inventions.

### ADVANTAGEOUS EFFECTS

The method of predicting and entering a character string and the electronic device in which the method is implemented according to the present invention are advantageous in that an intended character string can be entered easily and fast because the intended character string can be selected by entering only some letters of the character string.

Further, according to the present invention, even though a user does not correctly remember individual letters forming a character string, the corresponding character string can be entered. Accordingly, there are advantages in that a user's efforts to search for correct letters forming a character string while entering the character string can be reduced and so user convenience can be improved.

Further, according to the present invention, although a user uses function keys while minimizing the use of function keys other than character enter keys which are frequently used at normal times, the user can enter a character string using function keys relatively frequently used when writing a common document, such as the space bar, the enter key, and the shift key. Accordingly, there are advantages in that a user's fatigue and inconvenience resulting from the use of less experienced function keys can be solved and also the speed of entry of a character string can be increased.

### DESCRIPTION OF DRAWINGS

FIG. 1 is a flowchart illustrating a method of predicting and entering a character string according to the present invention;

FIG. 2 is a perspective view of a computer for implementing the method of predicting and entering a character string according to the present invention;

FIG. 3 is a front view of a mobile phone for implementing the method of predicting and entering a character string according to the present invention;

FIG. 4 is a front view of a PDA for implementing the method of predicting and entering a character string according to the present invention;

FIG. 5 is a state diagram showing a case in which an English character string called ‘communication’ is entered in accordance with the present invention;

FIG. 6 is a state diagram showing a case in which an English character string called ‘student’ is entered in accordance with the present invention;

FIG. 7 is a state diagram showing a case in which an English character string called ‘stationary’ is entered in accordance with the present invention;

FIG. 8 is a state diagram showing a case in which a Korean character string called [symbol] is entered in accordance with the present invention; and

FIG. 9 is a state diagram showing a case in which a Korean character string called [symbol] is entered in accordance with the present invention.

### MODE FOR INVENTION

Hereinafter, a method of predicting and entering a character string and an electronic device in which the method is implemented according to the present invention are described with reference to the accompanying drawings.

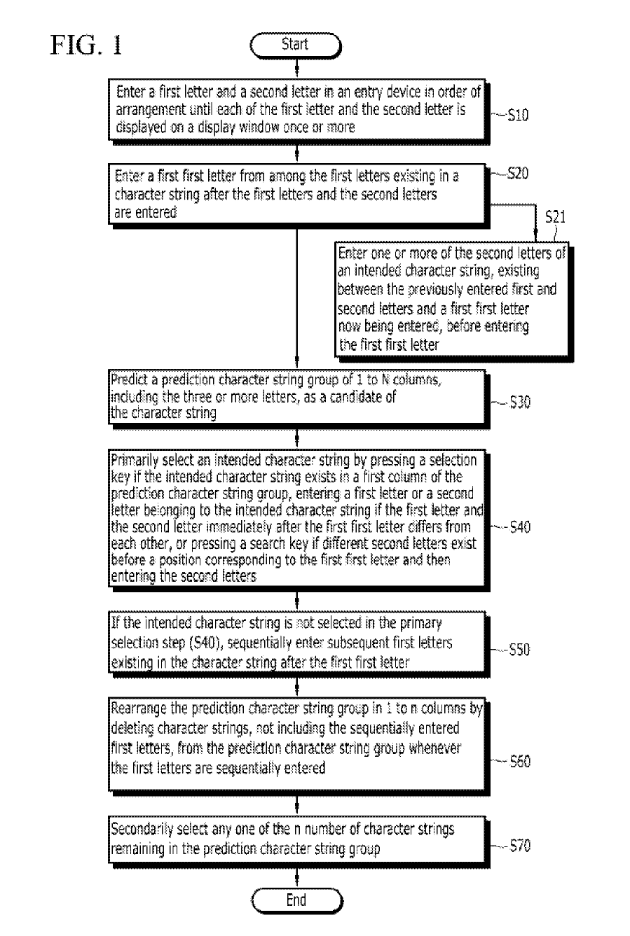

FIG. 1 is a flowchart illustrating a method of predicting and entering a character string according to the present invention.

Referring to FIG. 1, in order to enter a character string composed of a combination of a first letter and a second letter, the first letter and the second letter are inputted to an entry device in order of arrangement of the first letter and the second letter belonging to the character string until each of the first letter and the second letter is represented in a display window once or more (S10).

Accordingly, assuming that a combination of the letters of the character string includes two first letters, one second letter, and one first letter immediately after the one second letter, both the first two first letters have to be entered before the one second letter is entered.

Meanwhile, assuming that a combination of the letters of the character string includes two second letters, one first letter, and one first letter immediately after the one first letter, both the first two second letters have to be entered before the one first letter is entered.

After the first letters and the second letters are entered, a first first letter of the first letters existing in the character string is entered (S20). That is, after each of the first letter and the second letter is entered once or more at step S10, one or more first letters can exist in the character string. Here, the first letter which first appears from among the one or more first letters is entered at step S20.

In this case, the step (S20) of entering the first first letter can further include a step (S21) of entering one or more of the second letters existing between the first letters and the second letters, already entered, and the first first letter to be entered, before the first first letter is entered.

In other words, when the first letter and the second letter are entered at step S10, as described above, if two or more first letters consecutively appear at the beginning of the character string, both the two or more first letters have to be entered. However, if two or more second letters consecutively appear immediately after the two or more first letters, it is enough to enter the first letter of the two or more second letters at step S10.

However, the step of S21 means that all the two or more second letters can be entered before the first first letter is entered at step S20.

At step S30, a prediction character string group of 1 to N columns, including the entered three or more letters, is predicted as a candidate of the character string and displayed on the display window. The number of character strings of the prediction character string group is changed according to entered character strings. Here, N corresponds to a certain natural number.

Further, if the prediction character string group includes many character strings including the entered three letters, all the character strings including the entered three letters may not be displayed. In this case, some of the character strings are displayed on the display window as the prediction character string group, and the remaining character strings are stored in a storage device (e.g., RAM).

In this case, although the character strings indicated as the prediction character string group may be alphabetically arranged, it is preferred that the character strings be sequentially arranged starting from a first column in order of character strings of high frequency.

A user can select an intended character string from the prediction character string group displayed as described (S40). This step is referred to as a primary selection step. Three kinds of methods can be used in the primary selection step.

In other words, in the first method, if an intended character string of an N number of character strings included in a prediction character string group exists in the first column of the prediction character string group, the corresponding character string is selected by pressing a selection key.

However, if the intended character string does not exist in the first column and first letters or second letters immediately after the first first letter differ from each other, the intended character string can be selected by entering a first letter or a second letter belonging to the intended character string in accordance with the second method.

Next, in the case in which different second letters exist before a position corresponding to the first first letter, the intended character string can be selected by pressing a search key and then entering the second letter in accordance with the third method.

In the case in which the intended character string is not selected in the primary selection step (S40) using the three kinds of methods, subsequent first letters existing in a character string posterior to the first first letter are sequentially entered (S50). That is, the step S50 means that, assuming that a specific character string is composed of a \textcircled{1} first letter, a second letter (\textcircled{2}), a first letter (\textcircled{3}), a first letter (\textcircled{4}), a second letter (\textcircled{5}), a first letter (\textcircled{6}), . . . in this order, the first letter (\textcircled{4}) and the first letter (\textcircled{6}) subsequent to the first first letter (\textcircled{3}) have to be sequentially entered.

In this case, the \textcircled{5} second letter may be entered between the first letter (\textcircled{4}) and the first letter (\textcircled{6}) without entering only the first letter.

Next, the prediction character string group of 1 to n columns is rearranged by deleting a character string, not including the sequentially entered first letters, from the prediction character string group whenever the first letters are sequentially entered (S60). In the step S60, when the prediction character string group is rearranged, the already entered second letters are also included. Here, n is a natural number which is smaller than or equal to N at step S30.

A user selects the intended character string from the rearranged prediction character string group (S70). This step is referred to as a secondary selection step. Three kinds of methods are used in the secondary selection step as in the primary selection step.

In the case in which a first letter or a second letter immediately after a letter now being entered differs in the character strings of the prediction character string group in the primary selection step (S40) and the secondary selection step (S70), it is preferred that the first letter or the second letter be distinguished from other letters and displayed so that an intended character string can be easily selected. For example, the different first letters or second letters may be distinguished from other letters in such a manner that they have different colors or different thicknesses from other letters or they are underlined.

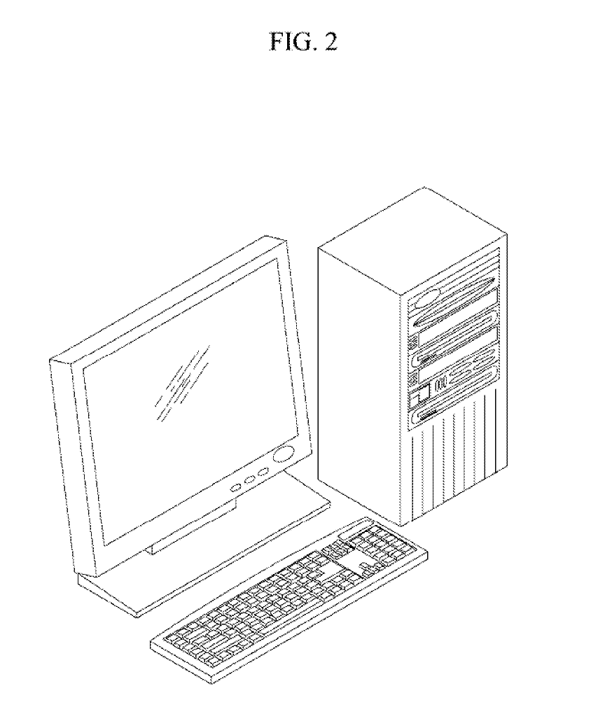

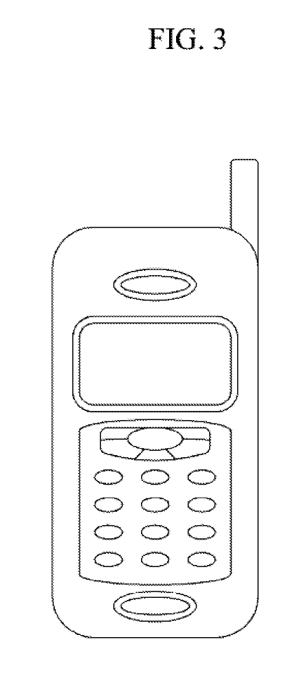

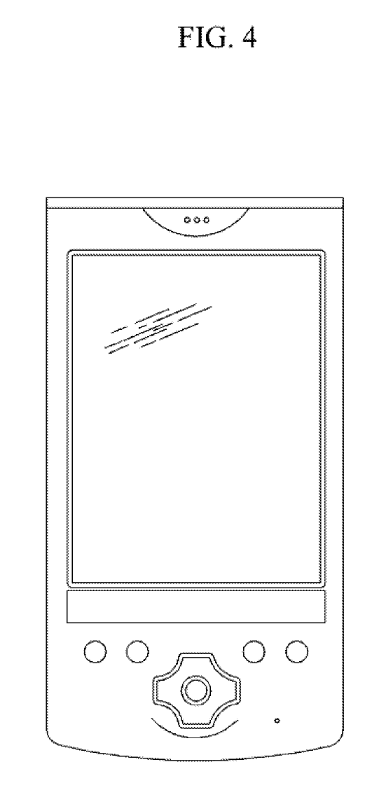

The above-described method of predicting and entering a character string according to the present invention can be implemented in various electronic devices. FIGS. 2 to 4 show examples of the devices. That is, FIG. 2 is a perspective view of a computer for implementing the method of predicting and entering a character string according to the present invention, FIG. 3 is a front view of a mobile phone for implementing the method of predicting and entering a character string according to the present invention, and FIG. 4 is a front view of a PDA for implementing the method of predicting and entering a character string according to the present invention.

In the present invention, a keyboard such as that shown in FIG. 2, a key enter device such as that shown in FIG. 3, or character buttons displayed in a touch screen such as that shown in FIG. 4 can be used as the entry device for entering the first letter and the second letter.

Further, in the present invention, a monitor such as that shown in FIG. 2, a screen output device such as that shown in FIG. 3, or a screen output device such as that shown in FIG. 4 can be used as the display window on which the first letters and the second letters and the prediction character string group generated when the first letters and the second letters are entered.

The computer, the mobile phone, and the PDA shown in FIGS. 2 to 4 are only examples of the electronic device for implementing the present invention, and the present invention is not implemented only in the devices. That is, any device other than the devices shown in FIGS. 2 to 4 can be adopted as long as it can enter the first letter and the second letter and display the entered letters.

A process of entering an English character string in a computer using the method of predicting and entering a character string according to the present invention is described below.

In the English language, ‘a’, ‘e’, ‘I’, ‘o,’ and ‘u’ of the 26 letters (‘a’ to ‘z’) of the alphabet are classified as vowels, and the remaining letters are classified as consonants. Here, ‘y’ and ‘w’ are classified as consonants, but may be included in vowels as needed. In the present embodiment, ‘y’ and ‘w’ are illustrated as vowels. Accordingly, it can be said that the 19 letters of the alphabet are the consonants and the remaining 7 letters are the vowels.

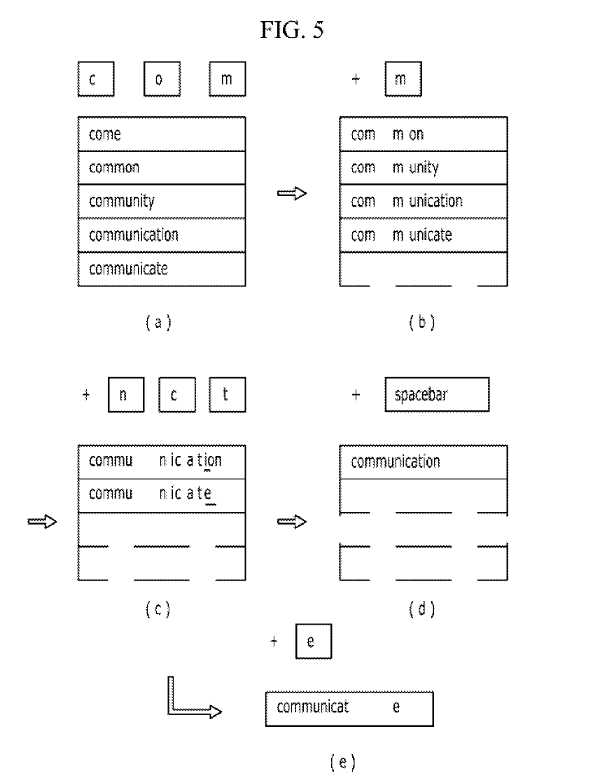

Here, the first letter according to the present invention corresponds to a consonant occupying a majority of the alphabet and the second letter according to the present invention corresponds to a vowel occupying a minority of the alphabet. A case in which an English character string is entered in the alphabet configured as above is described with reference to FIGS. 5 to 7.

FIGS. 5(a) to 5(d) show cases in which an English character string called ‘communication’ is entered in accordance with the present invention. Here, a method of entering the character string ‘communication’ can basically include a method of entering the alphabet of the character string from beginning to end. However, if the character string ‘communication’ is entered as described above, not only a relatively long character string, such as ‘communication’, has to be correctly memorized, but also a lot of time is taken to enter the long character string.

However, if the character string ‘communication’ is entered in accordance with the entry method according to the present invention, the character string can be entered relatively easily and fast.

That is, in order to enter the character string ‘communication’ in accordance with the entry method of the present invention, first, the consonant and the vowel of the character string ‘communication’ are entered until each of the consonant and the vowel appears in the display window once or more. In other words, the consonant ‘c’ and the vowel ‘o’ are sequentially entered. Accordingly, a condition that each of the consonant and the vowel must be entered once or more by entering the consonant ‘c’ and the vowel ‘o’ is satisfied.

Next, a consonant, appearing next to the consonant ‘c’ and the vowel ‘o’, is searched for and entered. That is, the consonant ‘m’ is entered. When up to the consonant ‘m’ is entered, a prediction character string group is generated in the display window on which the letters entered in the entry device are displayed, as shown in FIG. 5(a). The generated prediction character string group is generated by searching a database for character strings, including the letters ‘com’, on the basis of the letters ‘com’ entered so far.

Here, English character strings including the ‘com’ are very much and thus all the character strings including the ‘com’ cannot be listed in the prediction character string group. Accordingly, only some character strings are displayed in the prediction character string group so that they can be seen by a user, and the remaining character strings not displayed in the prediction character string group are stored in a storage device (e.g., RAM) by an application program so that reference can be made to the remaining character strings when further letters are entered.

Further, some character strings displayed in a prediction character string group may be arranged in order of the alphabet, but it is preferred that they be arranged in order of high frequency so that character strings frequently used are displayed in the prediction character string group.

In this case, if an intended character string to be entered by a user is ‘come’ at the top of the prediction character string group (i.e., existing in the first column of the prediction character string group), the user can directly select the character string ‘come’ by pressing a selection key (e.g., spacebar).

Further, if a consonant or a vowel right after the character string ‘com’ differs in the character strings of the prediction character string group, a user can directly select the corresponding character string by entering the consonant or the vowel.

However, in the present embodiment, since the character string to be entered is ‘communication’, it is impossible to directly select the intended character string at this moment. Accordingly, a task of entering one or more character strings appearing next to the character string ‘com’ is required.

Accordingly, the consonant ‘m’ appearing next to the ‘com’ is entered. When the consonant ‘m’ is entered, character strings, not including the consonant ‘m’ next to the ‘com’, are deleted from an N number of character strings arranged in the prediction character string group when the ‘com’ is entered. Further, the remaining prediction character string group (including a plurality of character strings not directly displayed in the prediction character string group and stored in the storage device) except the deleted character strings is sequentially arranged from a first column to an n column.

That is, in the case in which the prediction character strings from a first column to a fifth column are displayed when the ‘com’ is entered as shown in FIG. 5(a), if the ‘m’ is further entered, the character string ‘come’ disposed in the first column does not include the ‘m’ following the ‘com’ and thus the ‘come’ is deleted from the prediction character string group. Further, a prediction character string group from which the ‘come’ has been deleted is rearranged from a first column to a fourth column, as shown in FIG. 5(b). Here, what the ‘m’ is displayed in bold strokes is to clearly show whether the ‘m’ is included in the displayed prediction character string.

The intended character string can be selected by entering a character string disposed in the first column of the rearranged prediction character string group through the selection key or can be selected by entering a consonant or a vowel if the consonant or the vowel immediately after the ‘m’ differs in the character strings included in the prediction character string group.

Otherwise, the above process is repeated by entering ‘n’ which is a consonant appearing next. Further, in the case in which the intended character string is not directly searched for even if the ‘n’ is entered, it is searched for by repeating the above process while sequentially entering ‘c’ and ‘t’.

That is, ‘c’, ‘o’, ‘m’, ‘m’, ‘n’, ‘c’, ‘t’, and ‘n’ are sequentially entered in order to enter the character string ‘communication’ so that the intended character string can be disposed in the first column of a prediction character string group or can be selected through a letter right after letters entered so far. In this case, a vowel placed between consonants existing after ‘c’, ‘o’, ‘m’, and ‘m’ are entered can also be entered in order of the same arrangement as when the consonant is entered.

Even in the case in which the vowel not the consonant is entered as described above, character strings not including a currently entered vowel are deleted from the prediction character string group, and the prediction character string group is rearranged on the basis of the remaining character strings other than the deleted character strings.

FIG. 5(c) shows letters displayed in a prediction character string group in the case in which ‘nct’ is entered after ‘comm’. In this case, since the intended character string ‘communication’ is disposed in the first column of the prediction character string group, the intended character string ‘communication’ is selected by pressing the selection key as shown in FIG. 5(d).

In the case in which an intended character string is ‘communicate’, vowels right after ‘t’ which is the last entered consonant in FIG. 5(c) differ (i.e., ‘i’ and ‘e’) (indicated by underlines in FIG. 5(c)) in ‘communication’ and ‘communicate’. Accordingly, the intended character string ‘communicate’ can be selected by entering the vowel ‘e’, as shown in FIG. 5(e).

In this case, as described above, the different vowels ‘i’ and ‘e’ immediately after the consonant ‘t’ in the character strings ‘communication’ and ‘communicate’ can be displayed in different colors or can be underlined, as shown in FIG. 5(c), in order to help a user select them.

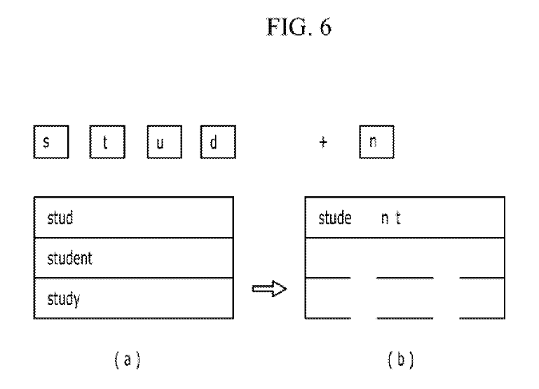

A case in which an English character string ‘student’ is entered is described with reference to FIG. 6.

First, each of a consonant and a vowel have to be entered once or more. Thus, ‘stu’ is entered, and a consonant ‘d’ is then entered. In this case, as shown in FIG. 6(a), a prediction character string group including the ‘stud’ is arranged in the display window.

If three character strings, including ‘stud’, ‘student’, and ‘study’, are arranged in a prediction character string group when ‘stud’ is entered as shown in FIG. 6(a), a user additionally enters a consonant ‘n’ disposed behind the ‘stud’ because he cannot directly select the character string ‘student’ from the current prediction character string group.

When the consonant ‘n’ is entered as described above, ‘stud’ and ‘study’ not including the consonant ‘n’ are deleted from the prediction character string group appeared when ‘stud’ was entered. Further, ‘student’ disposed in the second column in FIG. 6(a) is disposed in the first column as shown FIG. 6(b). In this case, a user can select the character string ‘student’ by pressing the selection key. Here, what the consonant ‘n’ is indicated in bold strokes is to clearly show whether the consonant ‘n’ is included in the displayed prediction character string.

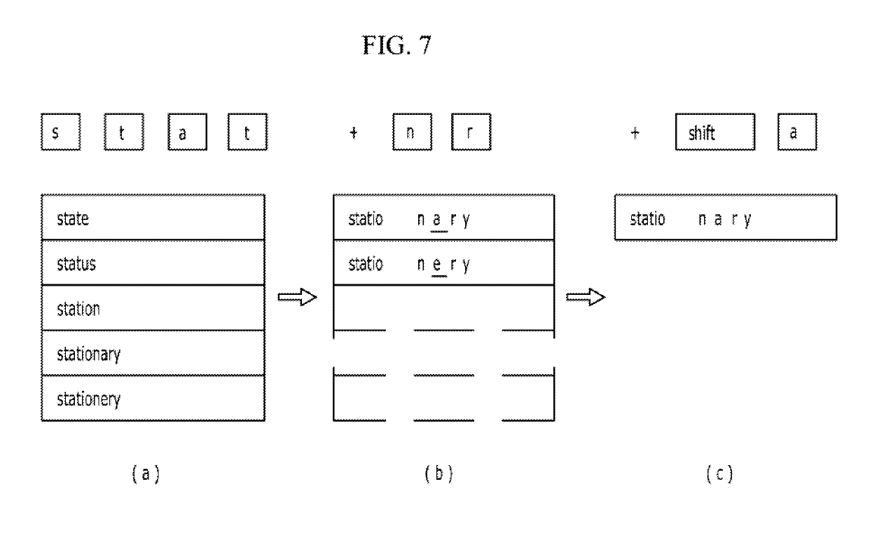

Next, a process of entering ‘stationary’ is described with reference to FIG. 7. First, ‘sta’ is entered so that each of a consonant and a vowel is displayed once or more. A consonant ‘t’ following the ‘sta’ is then entered.

For example, 5 character strings can be displayed in a prediction character string group including the ‘stat’, as shown in FIG. 7(a). In this case, a user further enters consonants ‘n’ and ‘r’ following the ‘stat’ because he cannot select the intended character string ‘stationary’ from the prediction character string group.

Accordingly, ‘state’, ‘status,’ and ‘station’ which do not include both the consonants ‘n’ and ‘r’ behind ‘stat’, from among ‘state’, ‘status’, ‘station’, ‘stationary’, and ‘stationery’ displayed in the prediction character string group when the ‘stat’ is entered, are deleted. Further, the remaining character strings other than the three deleted character strings are rearranged as shown in FIG. 7(b).

Accordingly, a user can select the intended character string ‘stationary’ by pressing the selection key because the ‘stationary’ is disposed in the first column of the prediction character string group in the rearranged prediction character string group.

However, if an intended character string is ‘stationery’, although ‘stat’, ‘n’, and ‘r’ are entered, the intended character string ‘stationery’ cannot be selected using the above-described method because the ‘stationery’ is disposed in the second column and a vowel immediately after the ‘r’ is ‘y’ corresponding to ‘stationary’ and ‘stationery’. Accordingly, in such a case, a search key (e.g., a shift key) is used to select the intended character string on the basis of letters previously disposed.

That is, in the case in which ‘stat’, ‘n’, and ‘r’ are entered, if ‘stationary’ is disposed in the first column of a prediction character string group and ‘stationery’ is disposed in the second column thereof, the eighth letters of the two character strings are different from each other (i.e., ‘a’ and ‘e’). However, since the two different letters are disposed in front of the entered ‘r’, ‘stationery’ is not entered even though ‘e’ of the letters ‘a’ and ‘e’ is entered. Accordingly, if a search key is pressed and the letter ‘e’ is entered in order to retrace the previously entered character string, the ‘stationery’ can be selected.

In this case, the letters ‘a’ and ‘e’ of the two character strings are different from each other. Accordingly, it is preferred that the two letters ‘a’ and ‘e’ be displayed in different colors from other letters or in bold strokes or underlined as shown in FIG. 7(b) so that a user can easily distinguish them.

Meanwhile, in the case in which two or more consecutive vowels appear at the beginning of a character string, all the two or more vowels have to be entered on the basis of the principle that each of a consonant and a vowel must be entered once or more. For example, in the case in which ‘australia’ is entered, the character string can be selected in such a way as to sequentially enter ‘a’, ‘u’, ‘s’, ‘t’, ‘r’, and ‘l’.

However, in the case in which two or more vowels are disposed immediately after a consonant appearing at the beginning of a character string, all the two or more vowels need not to be entered. This is because the principle that each of a consonant and a vowel must be entered once or more is satisfied by entering the consonant appearing at the beginning of the character string and then entering a vowel appearing at the beginning from among the two or more vowels.

For example, in the case in which ‘beautiful’ is entered, only the vowel ‘e’ of the three vowels ‘e’, ‘a’, and ‘u’ appearing immediately after the consonant ‘b’ may be entered. However, two or more vowels, including the vowel ‘e’, may be entered. It should be noted that the order of the entry must be the same as the order of the two or more vowels arranged in the character string.

A process of entering a Korean character string in a computer using the method of predicting and entering a character string according to the present invention is described below.

The Korean language includes 14 consonants from [symbol] to [symbol] eight numbers of [symbol] to [symbol] and vowels in which the eight vowels are combined. Here, a vowel of a combined form (e.g., [symbol] can be determined to be two vowels strictly speaking, but is determined to be one neuter gender in the Korean syntax. Accordingly, in the present invention, the vowel of a combined form (e.g., [symbol] is considered as one vowel.

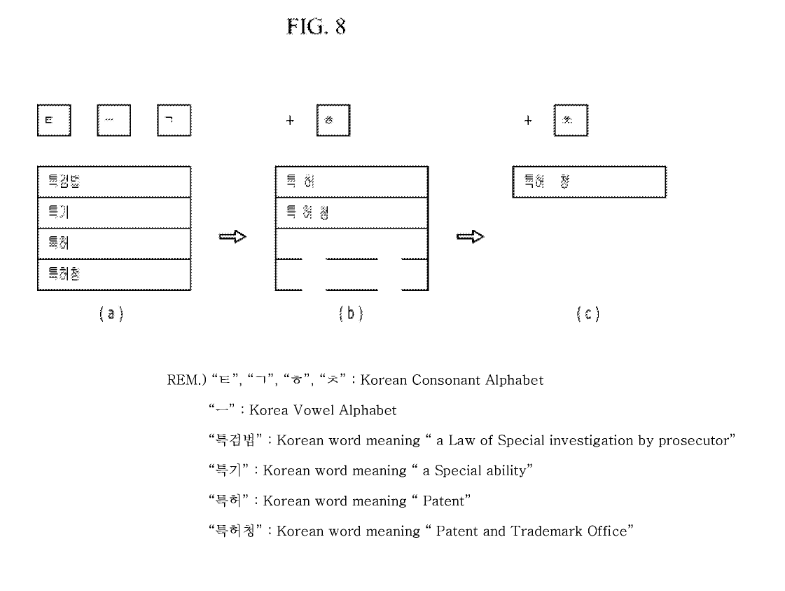

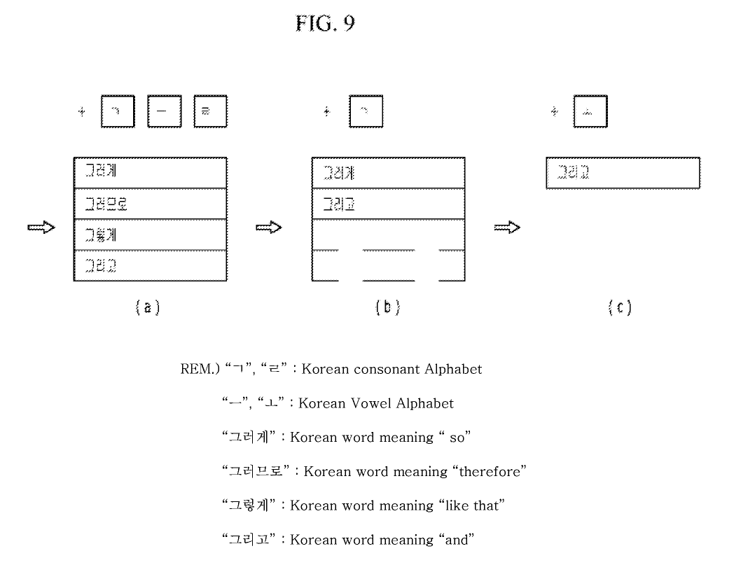

A first letter according to the present invention corresponds to the consonant of the Korean language, and a second letter according to the present invention corresponds to the vowel thereof. A case in which a Korean character string is entered on the basis of the consonants and the vowels of the Korean language is described with reference to FIGS. 8 and 9.

FIG. 8 shows the case in which the Korean character string [symbol] is entered. To this end, first, [symbol] and [symbol] (a consonant and a vowel, respectively) are entered so that each of the consonant and the vowel is entered once or more. [symbol] (i.e., a consonant appearing next to the vowel [symbol] is then entered.

Accordingly, a prediction character string group, including the [symbol] [symbol] and [symbol] is generated from a character string database, as shown in FIG. 8(a). Here, [symbol] which is a consonant appearing next to the consonant [symbol] is further entered because the intended character string [symbol] cannot be directly selected from the generated the prediction character string group.

As the [symbol] is added, [symbol] and [symbol] (i.e., character strings not including the [symbol] are deleted from the prediction character string group, and only [symbol] and [symbol] (i.e., character strings including the [symbol] are rearranged in a prediction character string group, such as that shown in FIG. 8(b).

In the prediction character string group shown in FIG. 8(b) including [symbol] and [symbol] a consonant appearing next to the [symbol] does not exist in [symbol] but a constant [symbol] exists in [symbol] Accordingly, a user can select the intended character string [symbol] by entering [symbol] as shown in FIG. 8(c).

For convenience of selection, in the case in which different consonants or vowels exist in the [symbol] and [symbol] the corresponding consonants or vowels may be displayed in different colors from other consonants and vowels or displayed in bold strokes as shown in FIG. 8(c).

Meanwhile, if it is sought to select [symbol] [symbol] is disposed in the first column of the prediction character string group shown in FIG. 8(b) and a user can directly select the [symbol] by pressing a selection key (e.g., spacebar).

A process of entering [symbol] is described below with reference to FIG. 9. First, in order to use each of a consonant and a vowel once or more, a consonant [symbol] and a vowel [symbol] are entered. A consonant [symbol] appearing immediately after the vowel [symbol] is then entered. Accordingly, a character string database is searched for a character string including the [symbol] [symbol] and [symbol] and the retrieved character string is displayed in the display window as a prediction character string group. FIG. 9(a) illustrates such as prediction character string group.

In the displayed prediction character string group, the intended character string [symbol] is disposed in a fourth column, and consonants and vowels immediately after the [symbol] [symbol] and [symbol] are different in the four character strings. Here, the [symbol] cannot be directly selected. Accordingly, [symbol] (i.e., a consonant immediately after the [symbol] is additionally entered.

In response to the entry of the [symbol] [symbol] and [symbol] (i.e., character strings not including the [symbol] is deleted from the prediction character string group and only [symbol] and [symbol] are rearranged as shown in FIG. 9(b). Although the [symbol] exists in the character string [symbol] after the consonant [symbol] a consonant [symbol] appears immediately after the [symbol] and thus the character string [symbol] is deleted from FIG. 9(b).

In order to select [symbol] in the rearranged character strings [symbol] and [symbol] shown in FIG. 9(b), a user enters [symbol] of [symbol] and [symbol] which are the last vowels of [symbol] and [symbol] In this case, it is preferred that the [symbol] and [symbol] be displayed in different colors from other consonants and vowels or displayed in bolder strokes than other consonants and vowels so that a user can easily distinguish them.

Meanwhile, the [symbol] and [symbol] have not only different [symbol] and [symbol] (i.e., the last vowels), but also different [symbol] and [symbol] (i.e., the second vowels). In this case, the intended character string [symbol] may be selected on the basis of the second vowels [symbol] and [symbol] That is, the intended character string [symbol] can be selected by pressing a search key (e.g., a shift key) and then entering [symbol] (i.e., the second vowel of the

[symbol]

It is also preferred that the two vowels [symbol] and [symbol] be displayed in different colors from other consonants and vowels or displayed in bold strokes so that a user can easily distinguish them.

If a method of entering the English language and the Korean language, such as that described above, is used, sentences written in the English language and the Korean language can be entered easily and fast. Further, the method of predicting and entering a character string according to the present invention can also be applied to languages other than the English language and the Korean language. For example, in the case in which the method is applied to the Chinese language or the Japanese language, the method can be used on the basis of pronunciation generated when the Chinese language or the Japanese language is read in the English language or the Korean language.

Meanwhile, unlike the above, only different letters as a result of comparison, from among presented prediction letters, may be distinguished and displayed. An intended prediction letter may be selected from among prediction letters by entering only the different letters. For example, ‘o’ in ‘common’, ‘t’ in ‘community’, ‘i’ in ‘communication’, and ‘e’ in ‘communicate’, from among the five prediction letters appearing in the state in which an entry has been performed as shown in FIG. 5(a), can be displayed in different colors or in bold strokes, and ‘come’ at the top can be selected by pressing the spacebar. Further, a desired prediction letter may be directly selected by entering the four prediction letters under the ‘come’, displayed in different colors or in bold strokes.

Here, the prediction letters have only to be distinguished and thus may be displayed with different letters in each word not a different letter.

For another example, in the case in which four prediction letters are displayed by entering [symbol] as shown in FIG. 8(a), [symbol] (i.e., a second letter) in [symbol] [symbol] in [symbol] [symbol] in [symbol] and [symbol] in [symbol] can be displayed in different colors or in bold strokes. Accordingly, the corresponding prediction letter can be directly entered by entering the corresponding letter.

The above method makes unnecessary the use of direction keys, a mouse, or numeric keys which are used to select a prediction letter. Further, in the case of the Chinese language, a corresponding stroke count may be distinguished and displayed. In the case of Hiragana or Katakana in the Japanese language, only different letters may be displayed, and a corresponding word may be entered by entering only the stroke count or the different letters.

While the invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A method of predicting and entering a character string, the method comprising:
a step (S10) of, in order to enter a character string composed of a combination of a first letter and a second letter, entering the first letter and the second letter in an entry device in order of arrangement of the first letter and the second letter belonging to the character string until each of the first letter and the second letter is displayed on a display window once or more;
a step (S20) of entering a first first letter from among the first letters existing in the character string after the first letters and the second letters are entered;
a step (S30) of predicting a prediction character string group of 1 to N columns, including the three or more letters, as a candidate of the character string on the basis of the entered three or more letters and displaying the predicted prediction character string group on the display window;
a step (S40) of primarily selecting an intended character string by pressing a selection key if the intended character string exists in a first column of the prediction character string group composed of an N number of character strings, by entering a first letter or a second letter appearing immediately after the first first letter, from among the N number of character strings, and belonging to the intended character string if the first letter or the second letter immediately after the first first letter differs, or by pressing a search key if different second letters exist before a position corresponding to the first first letter in the N number of character strings and then entering the second letters belonging to the intended character string;
a step (S50) of, if the intended character string is not selected in the primary selection step, sequentially entering subsequent first letters existing in the character string after the first first letter;
a step (S60) of rearranging the prediction character string group in 1 to n columns by deleting character strings, not including the sequentially entered first letters, from the prediction character string group whenever the first letters are sequentially entered; and
a step (S70) of secondarily selecting any one of the n number of character strings remaining in the prediction character string group.

2. The method of claim 1, wherein the step (S20) of entering the first first letter further comprises a step (S21) of entering one or more of the second letters of the intended character string, existing between the previously entered first and second letters and a first first letter now being entered, before entering the first first letter.

3. The method of claim 1, wherein:
in the sequential entry step (S50), one or more of second letters disposed between the subsequent first letters, together with the subsequent first letters, are entered in order of arrangement of the letters of the character string, and
in the rearrangement step (S60), the prediction character string group, including the entered one or more second letters, is rearranged.

4. The method of claim 1, wherein in the secondary selection step (S70), a character string disposed in a first column of the prediction character string group arranged in the 1 to n columns is selected by pressing the selection key.

5. The method of claim 4, wherein in the secondary selection step (S70), if a first letter or a second letter immediately after a letter now being entered differs in each of the character strings included in the prediction character string group arranged in the 1 to n columns, a character string belonging to a prediction character string group, including the first letter or the second letter, is selected by entering a first letter or a second letter to distinguish the character strings from each other.

6. The method of claim 4, wherein in the secondary selection step (S70), if there is a different second letter before a position corresponding to a first or second letter now being entered in an n number of character strings, the intended character string is selected by pressing the search key and then entering the second letter belonging to the intended character string.

7. The method of claim 5, wherein the first or second letter to distinguish the character strings from each other is distinguished from previously displayed characters and displayed.

8. The method of claim 1, wherein:
the first letter is a consonant, and
the second letter is a vowel.

9. The method of claim 1, wherein in the step (S30) of displaying the prediction character string group, the prediction character string group is sequentially arranged starting from a first column of a prediction word group in order of character strings of high frequency.

10. An electronic device for implementing an entry of letters using a method of predicting and entering a character string according to claim 1.
